(19) United States
(12) Patent Application Publication
(10) Pub. No.: US 2008/0198819 A1
(43) Pub. Date: Aug. 21, 2008

(54) Concurrent Ad-Hoc and Infrastructure Connectivity for a Wireless LAN

(75) Inventors: Patrick Martin Brown, Holbrook, NY (US); William J. Sakoda, East Setauket, NY (US); Paul Raymond Seiter, Port Jefferson Station, NY (US)

Correspondence Address: INGRASSIA FISHER & LORENZ, P.C., 7010 E. COCHISE ROAD, SCOTTSDALE, AZ, 85253, US

(73) Assignee: SYMBOL TECHNOLOGIES, INC., Holtsville, NY (US)

(21) Appl. No.: 11/677,159

(22) Filed: Feb. 21, 2007

(51) Int. Cl. H04Q 7/24

(52) U.S. Cl. 370/338

(57) ABSTRACT

A system and methods are disclosed for concurrent ad-hoc and infrastructure connectivity for a wireless local area network. The system comprises an infrastructure access point, an ad-hoc personal device, and a wireless terminal device configured to communicate concurrently with the infrastructure access point and the ad-hoc personal device. Furthermore, the system allows selection of a common communication operation mode. If the common communication operation mode indicates a concurrent operation mode, a wireless terminal is configured to communicate concurrently with an infrastructure access point and an ad-hoc personal device.

### TECHNICAL FIELD

The present invention relates generally to wireless networking, and more particularly relates to concurrent operation of heterogeneous wireless networks.

### BACKGROUND

A wireless local area network (WLAN) can give wireless terminal devices the ability to physically move from place to place while maintaining a wireless connection to a local area network without being connected by wires. A WLAN relies on infrastructure components that establish associations, such as data communication links, with wireless terminal devices. A wireless terminal device communicates with an infrastructure access point device via a wireless data communication channel, which in turn communicates with other network components via traditional wired interfaces. Many deployments of WLANs, involve the use of wireless terminal devices serving a number of wireless ad-hoc devices, which are devices that are capable of forming and organizing themselves into networks of arbitrary topology. A WLAN infrastructure may be configured to support a plurality of wireless ad-hoc devices using a single wireless terminal device.

Existing wireless terminal devices connect separately to an ad-hoc network in an ad-hoc network mode, or to an infrastructure network in an infrastructure network mode. Wireless terminal device applications using one mode have to suspend communication while the second mode is communicating, and concurrent operation is not possible. For example, a Bluetooth headset and an 802.11b/g WLAN use the same frequency band by definition of the Bluetooth and 802.11b/g radio standards. A conventional wireless terminal device connected to a Bluetooth headset and an 802.11b/g WLAN must suspend operation of the Bluetooth mode to operate in the 802.11b/g mode and vice versa. It is desirable to have both headset and LAN services available concurrently with minimal communication latency.

### BRIEF SUMMARY

A system, device and methods are disclosed for concurrent ad-hoc and infrastructure connectivity for a WLAN. The system comprises an infrastructure access point, an ad-hoc device, and a wireless terminal device configured to communicate concurrently with the infrastructure access point and the ad-hoc device.

A wireless terminal device is disclosed that is configured to communicate concurrently with an infrastructure access point and an ad-hoc device in a wireless network. The wireless terminal device comprises a radio module configured to wirelessly receive signals that convey a plurality of parameters corresponding to a plurality of communication operation modes on the wireless network, and a processing logic element coupled to the radio module and configured to select the communication operation modes in response to a user or automatic selection criteria. The wireless terminal device may be configured, using the parameters, to select an infrastructure and ad-hoc device communication operation mode, and communicate concurrently with the infrastructure access point and the ad-hoc device, if the communication operation mode indicates a concurrent operation mode.

A method is disclosed for operating a concurrent communication system having a wireless terminal device in a WLAN. The method begins by selecting a first communication operation mode for a first device, a second communication operation mode for a second device, and a common operation mode. If the common operation mode indicates a concurrent operation mode, then the wireless terminal device communicates concurrently with the first and second device.

A further method is disclosed for operating a concurrent ad-hoc and infrastructure connectivity system having a wireless terminal device in a WLAN. The method begins with a user or automatic selection of an infrastructure access point communication operation mode and an ad-hoc device communication operation mode independent from one another. A system communication operation mode is then selected, and if the system communication operation mode indicates a concurrent operation mode, the wireless terminal device is configuring to communicate concurrently with an infrastructure access point and an ad-hoc device.

### BRIEF DESCRIPTION OF THE DRAWINGS

A more complete understanding of the embodiments of the present invention may be derived by referring to the detailed description and claims when considered in conjunction with the following figures, wherein like reference numbers refer to similar elements throughout the figures.

FIG. 1 is a schematic representation of a WLAN environment having ad-hoc devices, an access point, and a wireless terminal device;

FIG. 2 is a schematic representation of a wireless terminal device configured for concurrent ad-hoc and infrastructure connectivity in accordance with an example embodiment of the invention;

FIG. 3 is a flow chart of a concurrent ad-hoc and infrastructure connectivity process for a WLAN configured in accordance with an example embodiment of the invention; and

FIG. 4 a flow chart of a concurrent ad-hoc and infrastructure data communication process for a WLAN configured in accordance with an example embodiment of the invention.

### DETAILED DESCRIPTION

The following detailed description is illustrative in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to wireless signal processing, wireless data transmission, WLANs, signaling, network control, and other functional aspects of the systems (and the individual operating components of the systems) may not be described in detail herein. The connecting lines shown in the various figures contained herein are intended to represent example functional relationships and/or physical couplings between the various elements. It should be noted that many alternative or additional functional relationships or physical connections may be present in a practical embodiment.

The following description may refer to elements or features being “connected” or “coupled” together. As used herein, unless expressly stated otherwise, “connected” means that one element/feature is directly joined to (or directly communicates with) another element/feature, and not necessarily mechanically. Likewise, unless expressly stated otherwise, “coupled” means that one element/feature is directly or indirectly joined to (or directly or indirectly communicates with) another element/feature, and not necessarily mechanically. Thus, although the figures may depict example arrangements of elements, additional intervening elements, devices, features, or components may be present in an actual embodiment (assuming that the functionality of the system is not adversely affected).

As used herein, the term “access point” means any component, device, feature, element, or function that is configured to receive/transmit wireless traffic from a wireless client device in a WLAN environment. Traditionally, an access point or an access point device refers to a hardware component that includes a radio module, memory, processing logic, and a network communication module that enables it to communicate with other network architecture components. For convenience, the term “access point” as used herein contemplates an access point device in the traditional sense, in addition to a subsystem that includes an access port device and a wireless switch. Moreover, the term “access point” contemplates any individual component, device, hardware, or system, and any combination thereof, that is configured to function in the manner described herein. The term “access point” in this context will include the “access port”. In the wireless networks access points are self contained units while access ports are centrally managed from a wireless back-end server. For purposes of this description, the terms “access point” and “access point” are synonymous.

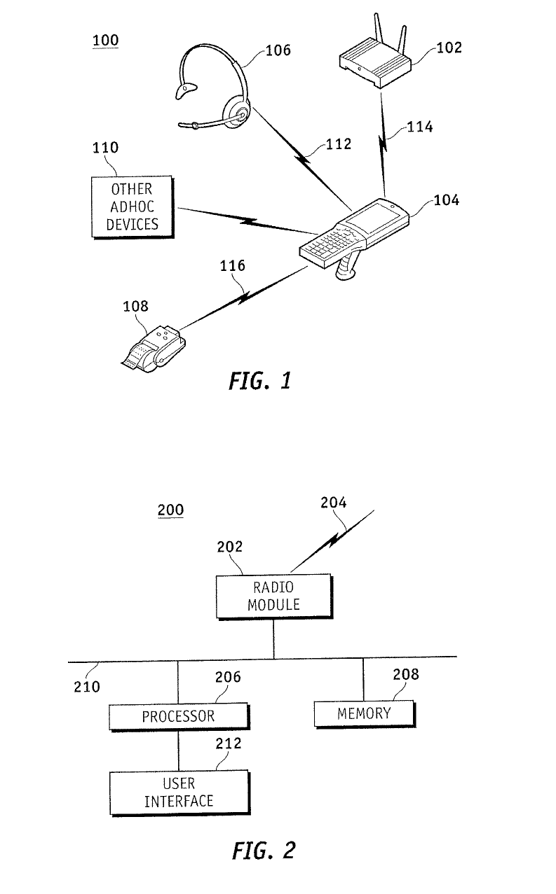

FIG. 1 is a schematic representation of a WLAN environment 100 having an infrastructure access point 102 a wireless terminal device 104, and ad-hoc devices, which may be personal devices such as a wireless audio headset 106, a mobile receipt printer 108, or other ad-hoc devices 110. WLAN environment 100 may be in compliance with an Ethernet protocol. A practical embodiment of WLAN environment 100 will include additional components and elements configured to support known or conventional operating features that need not be described in detail herein.

An infrastructure access point 102 relies on infrastructure components that establish a wireless data communication link 114 with wireless terminal device 104. A wireless terminal device 104 communicates, via the wireless data communication link 114, with the infrastructure access point 102, which in turn communicates with other network components via traditional wired interfaces (not shown in FIG. 1). An infrastructure access point 102 can support a plurality of different groups or categories of wireless terminal devices 104 each with a wide range of possible data rates or bandwidth requirements, which infrastructure access point 102 may support through compliance with an Ethernet protocol. For example, an 802.11 access point could support a computer at 10 megabits per second, or a wireless internet telephone at 16 kilobits per second concurrently.

For this embodiment, the wireless terminal device 104 is a data entry device also functioning as a bridge between the infrastructure access point 102 and the ad-hoc personal devices 108/110/112. Alternatively, the wireless terminal device 104 may be any suitably configured portable, mobile, stationary, or handheld device. The wireless terminal device 104 is explained in detail below in the context of FIG. 2.

Generally, ad-hoc devices are individual parts of a wireless ad-hoc network. A wireless ad-hoc network is a self-configuring network of mobile routers and associated hosts connected by wireless links, which may form an arbitrary topology. The ad-hoc devices are free to be moved randomly and organize arbitrarily, so a wireless ad-hoc network's topology may change rapidly and unpredictably. Such a wireless ad-hoc network may be in compliance with an Ethernet protocol, and may operate in a standalone fashion, or may be connected to a larger Ethernet, and assume varying degrees of mobility within a bounded space, usually with all nodes within a few hops of each other, and usually with nodes sending data at a constant rate. In this regard, various parameters are determined for selection of such ad-hoc devices in the WLAN, and different protocols may be evaluated based on the packet drop rate, the overhead introduced by the routing protocol, and other measures including, for example, without limitation: transmission power, listening power, encryption, band frequency band selection and the like.

In this example embodiment, ad-hoc devices 106/108/110 are individual parts of an ad-hoc personal area network (PAN). A PAN is a network used for communication among devices close to a person such as telephones and personal digital assistants. The devices may or may not be in the possession of the person in question. A PAN typically has a range of about 10 meters, although ranges may reach about 100 meters or more. PANs may be wired using computer buses such as USB and FireWire, or may be wireless using network technologies such as IrDA and Bluetooth. The need for a Bluetooth device could be removed if the required dedicated peripheral has support for the 802.11b/g protocol. PANs may be used for communication among the ad-hoc personal devices 106/108/110 themselves, or for connecting to a higher level network and the internet. The embodiment described herein allows concurrent accessibility to both the infrastructure network and the PAN from wireless terminal device 104.

Wireless headset 106 is a wireless personal network device that is equivalent to a telephone handset in functionality, but designed to fit on a person's head to leave both hands free. Like a telephone handset, the headset contains a microphone and one or two speakers for one or both ears.

Mobile receipt printer 108 may be, without limitation, a compact, lightweight direct thermal mobile printer such as a Zebra QL 220. This kind of device is useful for real-time mobile applications including, without limitation: price marking, shelf labeling, inter-store transfers, direct store vendor delivery and verification, mobile point of sale at boutique stores where space is at a premium, and secure transfer of sensitive data such as price lists, customer information, and medical records.

Other ad-hoc devices 110 may be, without limitation: a bar-code scanner, a digital music player, a portable computer, or numerous devices yet to be developed.

FIG. 2 is a schematic representation of a wireless terminal device 200 that is suitably configured for concurrent ad-hoc and infrastructure connectivity in accordance with an example embodiment of the invention. A practical embodiment of wireless terminal device 200 will include additional components and elements configured to support known or conventional operating features that need not be described in detail herein.

In the example embodiment, the wireless terminal device 200 transmits and receives data wirelessly to and from the infrastructure device (not shown in FIG. 2) as explained in the context of FIG. 1 above. An infrastructure device connects wireless terminal devices to other users within the network and can also serve as the point of interconnection between a WLAN and a fixed wire network. Each infrastructure device can serve multiple wireless terminal devices within a defined network area. As a wireless terminal device moves beyond the range of one infrastructure device, the wireless terminal device can associate to another infrastructure device, e.g., a candidate infrastructure device. In this regard, a wireless terminal device may be configured to communicate with an infrastructure device that is available within the range. A wireless terminal device 200 may be, for example, without a limitation, a wireless laptop computer or a mobile phone.

Wireless terminal device 200 generally includes: a physical housing (not shown), a radio module 202, a processor architecture 206, an appropriate amount of memory 208 and a user interface 212. A practical wireless terminal device 200 may include any number of radio modules, any number of processor devices, and any number of memory elements; the illustrated device depicts a simple embodiment for ease of description. These and other elements of wireless terminal device 200 may be interconnected together using a bus 210 or any suitable interconnection arrangement. Such interconnection facilitates communication between the various elements of wireless terminal device 200.

Radio module 202, which includes a receiver and a transmitter (or a transceiver), is configured to communicate with infrastructure devices via a wireless data communication link 204 to wirelessly receive signals that convey a plurality of parameters corresponding to communication operation modes from the wireless LAN. The parameters may include, without limitation, frequency/channel to use, authentication, network type, network identification, encryption, internet address entry, transmission power level, listening power level, battery usage, encryption, band frequency band selection, and the like.

Radio module 202 may cooperate with a suitably configured RF antenna arrangement (not shown) that supports the particular wireless communication protocol. In the example embodiment, radio module 202 is configured to support WLAN connectivity in compliance with established IEEE standards, such as 802.11, 802.11a, 802.11b, 802.11d, 802.11e and 802.11g. Radio module 202 may be configured to support alternate or additional wireless data communication protocols, including future variations of 802.11 such as 802.11n.

Processor architecture 206 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. In practice, processor architecture 206 includes processing logic that is configured to carry out the functions, techniques, and processing tasks associated with the operation of wireless terminal device 200. In particular, the processing logic is configured to support the concurrent infrastructure and ad-hoc connectivity techniques described herein.

Furthermore, the steps of a method or algorithm described in connection with the embodiments disclosed herein may be embodied directly in hardware, in firmware, in a software module executed by processor architecture 206, or in any practical combination thereof. A software module may reside in memory 208, which may be realized as RAM memory, flash memory, ROM memory, EPROM memory, EEPROM memory, registers, a hard disk, a removable disk, a CD-ROM, or any other form of storage medium known in the art. In this regard, memory 208 can be coupled to processor architecture 206 such that processor architecture 206 can read information from, and write information to, memory 208. In the alternative, memory 208 may be integral to processor architecture 206. As an example, processor architecture 206 and memory 208 may reside in an ASIC.

User interface 212 is configured to allow user selection of the communication operation mode. User interface 212 is coupled to the processor architecture 206, and is configured to allow user selection of: an infrastructure communication operation mode, an ad-hoc personal device communication operation mode, and a common communication operation mode. The user interface is the aggregation of means by which people (the users) interact with a particular machine, system, device, or computer program. The user interface provides means of: Input, allowing the users to manipulate a system, and Output, allowing the system to produce the effects of the users' manipulation. To work with a system, the users need to be able to control the system and assess the state of the system. The term user interface is often used in the context of computer systems and electronic devices. The term refers to the ‘layer’ that separates a human that is operating a machine from the machine itself. The design of a user interface affects the amount of effort the user must expend to provide input for the system and to interpret the output of the system, and how much effort it takes to learn how to do this. Usability is the degree to which the design of a particular user interface takes into account the human psychology and physiology of the users, and makes the process of using the system effective, efficient and satisfying. Usability is mainly a characteristic of the user interface, but is also associated with the functionalities of the product. It describes how well a product can be used for its intended purpose by its target users with efficiency, effectiveness, and satisfaction, also taking into account the requirements from its context of use. The user interface may be, without limitation, a graphical user interface (GUI) allowing, without limitation, user selection of the parameters explained above.

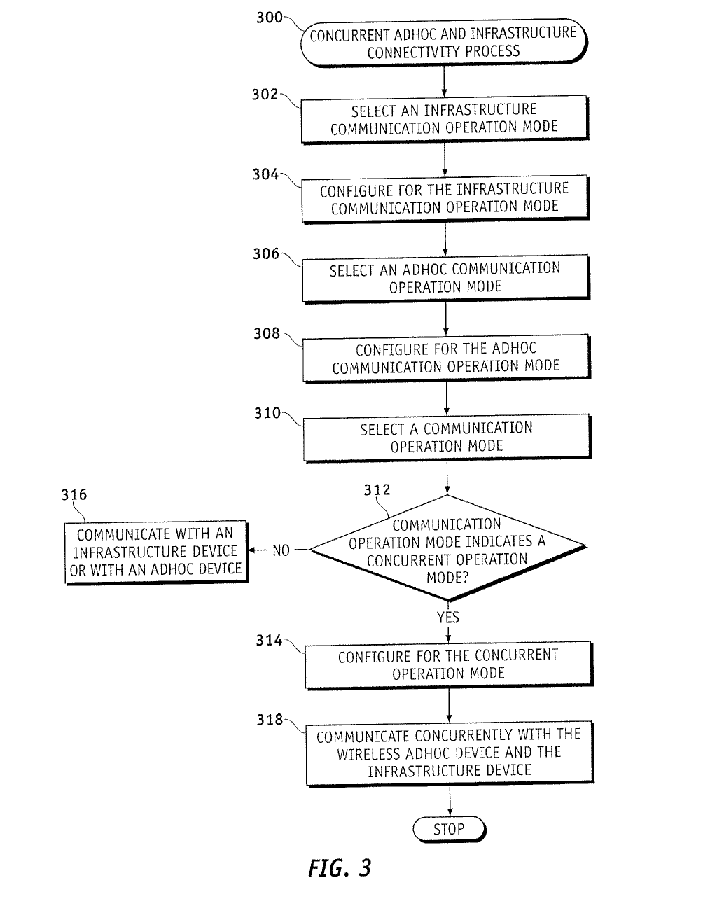

FIG. 3 is a flow chart of a concurrent ad-hoc device and infrastructure connectivity process 300 for a WLAN configured in accordance with an example embodiment of the invention which may be suitable for 802.11 direct sequence and OFDM WLAN radios. Process 300 may be performed by a wireless terminal device, an access point and an ad-hoc personal device configured in accordance with an example embodiment of the invention, and process 300 may be carried out in conjunction with the communication session depicted in FIG. 1. The various tasks performed in connection with process 300 may be performed by software, hardware, firmware, or any combination thereof. For illustrative purposes, the following description of process 300 may refer to elements mentioned above in connection with FIGS. 1-2. In practical embodiments, portions of process 300 may be performed by different elements of the described systems. It should be appreciated that process 300 may include any number of additional or alternative tasks, the tasks shown in FIG. 3 need not be performed in the illustrated order, and process 300 may be incorporated into a more comprehensive procedure or process having additional functionality not described in detail herein.

Process 300 may begin by selecting an infrastructure communication operation mode (task 302), which may be selected by a user through a user interface or via a stored or automatic selection. Then, a wireless terminal device is configured according to the infrastructure communication operation mode (task 304), wherein the infrastructure communication operation mode may comprises a wireless LAN configuration in compliance with IEEE standard 802.11 for communication. In this regard, the wireless LAN is configured by selecting respective parameters as explained in the context of FIG. 1-2 above. Upon completion of the configuring step, the wireless terminal device is capable of supporting the selected infrastructure communication operation mode.

Process 300 then selects an ad-hoc personal device communication operation mode (task 306), which may be selected by a user through a user interface or via a stored or automatic selection. The ad-hoc personal device communication operation mode allows selection of one of the ad-hoc personal devices as explained above in the context of FIG. 1. Then, the wireless terminal device is configured according to the ad-hoc personal device communication operation mode (task 308), wherein the ad-hoc personal device communication operation mode may be associated with the operation of a wireless LAN configuration in compliance with IEEE standard 802.11 for communication. In this regard, the wireless LAN is configured by selecting respective parameters as explained in the context of FIG. 1. above. Upon completion of this configuring step, the wireless terminal device is capable of supporting the selected personal device communication operation mode.

Process 300 then selects a system communication operation mode (task 310). If the system/common communication operation mode does not indicate a concurrent operation mode (inquiry task 312), the wireless terminal device is configured to communicate separately with an infrastructure access point or an ad-hoc personal device (task 316). If the system/common communication operation mode indicates a concurrent operation mode (inquiry task 312), the wireless terminal device is configured to communicate concurrently with the infrastructure access point and the ad-hoc personal device (task 314). Thus, the wireless terminal device can communicate concurrently with both an infrastructure access point and an ad-hoc personal device (task 318). A suitable data communication process for the concurrent ad-hoc and infrastructure connectivity in an 802.11 WLAN is described in further detail below.

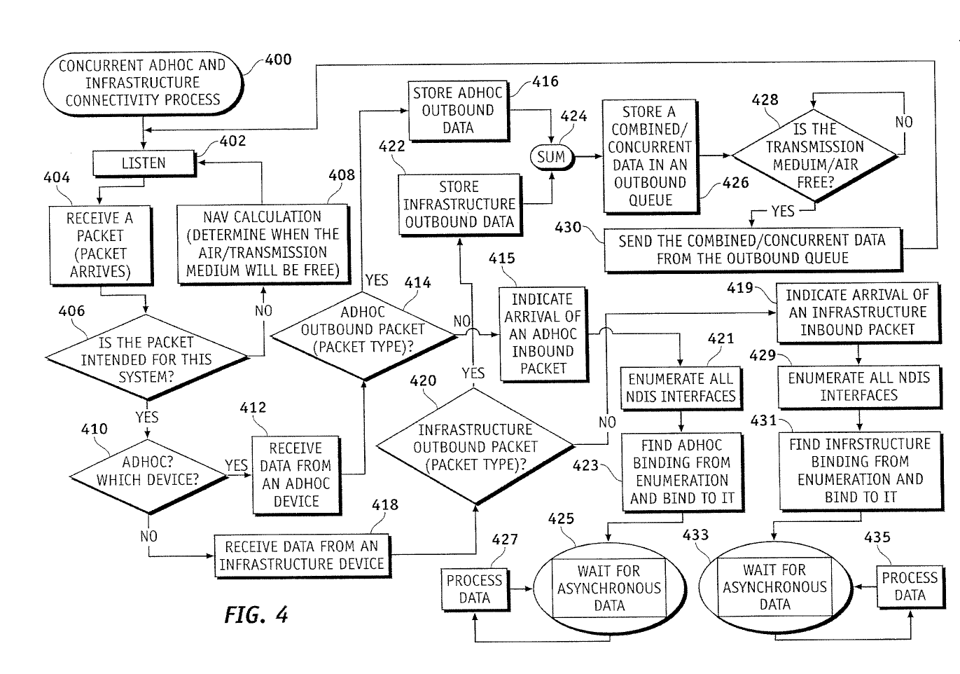

FIG. 4 is a flow chart of a concurrent ad-hoc and infrastructure data communication process 400 for a WLAN configured in accordance with the example embodiment of the invention. Process 400 may be suitable for 802.11 direct sequence and OFDM WLAN radios. Process 400 may be performed by a wireless terminal device, an access point, and an ad-hoc personal device configured in accordance with an example embodiment of the invention. Process 400 may be carried out in conjunction with the communication session depicted in FIG. 1. The various tasks performed in connection with process 400 may be performed by software, hardware, firmware, or any combination thereof. For illustrative purposes, the following description of process 400 may refer to elements mentioned above in connection with FIGS. 1-2. In practical embodiments, portions of process 400 may be performed by different elements of the described systems. It should be appreciated that process 400 may include any number of additional or alternative tasks. The tasks shown in FIG. 4 need not be performed in the illustrated order, and process 400 may be incorporated into a more comprehensive procedure or process having additional functionality not described in detail herein.

To establish a concurrent communication with a wireless ad-hoc device and an infrastructure device, process 400 begins by listening (task 402) to data transmission for capturing a packet intended for a wireless terminal device. In an 802.11 WLAN, one node/computer does not send a packet exclusively to another node/computer. Instead, it puts the address of the desired destination or receiving station in the header of the packet, and puts the packet out onto the airwaves. Each network node within range listens to the transmission and uses the first address in the 802.11 WLAN medium access control (MAC) header to determine if that node should process it. If the packet was intended for a particular computer/node, that machine captures it, puts it in memory, and then passes it to the next layer of the protocol stack for processing. If the message was received intact, the receiving node typically sends an ACK to acknowledge this.

All devices within range receive a packet (task 404) that contains the wireless terminal device's address. A device ignores the packet when the first address field of the packet's MAC header does not include the address of that device. Only the wireless terminal device, finding its own address in that first field, processes the packet further. If the packet was not intended for the wireless terminal device (inquiry task 406), then process 400 performs a network allocation vector (NAV) calculation (task 408) to determine the next available time slot for transmission of output, and keeps it in an outbound packet for later transmission. The NAV calculation can be made with prediction since according to the 802.11b/g protocol, the individual radios in the network coordinate when they have a slot available to send and process data. The value of NAV, which is a counter resident at each wireless terminal device, represents the amount of time that the previous frame needs to send its frame. The NAV must have a value of zero before a wireless terminal device can attempt to send a frame.

Prior to transmitting a frame, a wireless terminal device calculates the amount of time necessary to send the frame based on the frame's length and data rate. The wireless terminal device places a value representing this time in the duration field in a header of a frame of each packet. When the wireless terminal devices receive the frame, they examine this duration field value and use it as the basis for setting their corresponding NAVs. This process reserves the medium for the sending infrastructure and/or ad-hoc devices. Process 400 then returns to listening (task 402).

If the packet was intended for the wireless terminal device (inquiry task 406), then process 400 captures it, puts it in memory for later processing, and proceeds to identify which device has sent the packet, i.e., an ad-hoc device or an infrastructure device (inquiry task 410). Identification information of each device is transmitted on the WLAN by each packet according to any of the IEEE 802 series standards. In this regard, the packet is read and decoded by the wireless terminal device to identify the device type (ad-hoc or infrastructure).

An ad-hoc device sends the ad-hoc packet to the wireless terminal device through the ad-hoc internet bind. In this regard, process 400 decodes the packet to determine whether the packet is sent from an ad-hoc device (inquiry task 410). If the packet is received from an ad-hoc device (task 412), then process 400 proceeds to determine the packet's type (inbound or outbound). In this regard, process 400 checks whether the ad-hoc packet is an ad-hoc outbound packet (wireless source data) (inquiry task 414) intended for going out of the wireless terminal device. If process 400 determines that the packet is an ad-hoc outbound packet (inquiry task 414), then process 400 stores the ad-hoc outbound data (task 416) for further processing. The stored ad-hoc outbound data is then added (task 424) to a stored outbound infrastructure data (explained below) and queued in a main outbound queue (426) of the wireless terminal device for later transmission. If process 400 determines (inquiry task 414) that the ad-hoc packet is an inbound packet (wireless sink data) which is coming into the wireless terminal device, then the wireless terminal device's processor generates a message indicating arrival of the ad-hoc inbound packet (task 415). When the wireless terminal device's processor generates and sends an asynchronous event signal (indicating arrival of the inbound packet) to the ad-hoc Network Driver Interface Specification (NDIS) driver, the application is bound to the binding layer that receives the data from the inbound packet. In this regard, the application that is going to receive the ad-hoc data first enumerates all of the ad-hoc interfaces (task 421). After the enumeration (task 421) the application finds an ad-hoc binding and binds to the ad-hoc interface (task 423). The application then waits for asynchronous data (task 425) until an inbound signal is received. Next, the application will process the ad-hoc inbound packet/data (task 427) and then return to wait for more asynchronous data arrival events (task 425).

Similarly, an infrastructure device sends the infrastructure packet to the wireless terminal device through the infrastructure internet bind. In this regard, process 400 decodes the packet to determine which device has sent the packet (inquiry task 410). If the packet is received from an infrastructure device (task 418), then process 400 proceeds to determine the type (outbound or inbound) of the packet. In this regard, process 400 checks whether the infrastructure packet is an outbound packet (wireless source data) intended for going out of the wireless terminal device (inquiry task 420). If process 400 determines that the infrastructure packet is an outbound packet (inquiry task 420) then process 400 stores the infrastructure outbound data for further processing (task 422). The stored infrastructure outbound data is then added to the stored outbound ad-hoc data (task 424), to obtain the concurrent/combined data, and queued (stored) in the main outbound queue (task 426) of the wireless terminal device for later transmission. If process 400 determines (inquiry task 420) that the infrastructure packet is an inbound packet (wireless sink data) which is coming into the wireless terminal device, then the wireless terminal device's processor generates a message indicating arrival of the infrastructure inbound packet (task 419). When the wireless terminal device's processor generates and sends an asynchronous event signal (indicating arrival of the inbound packet) to the infrastructure NDIS driver, the application is bound to the binding layer that receives the data from the inbound packet. The application that is going to receive the infrastructure data first enumerates all of the interfaces (task 429). After the enumeration (task 429), the application finds an infrastructure binding and binds to the infrastructure interface (task 431). The application would then block/wait for asynchronous data (task 433) until an inbound signal is received. Next, the application will process the infrastructure inbound packet/data (task 435) and return to wait for more asynchronous data arrival events.

If the transmission channel is in use, the wireless terminal must wait before attempting to send the ad-hoc and/or the infrastructure data through the transmission medium/air again. This ensures that multiple wireless terminal devices wanting to send data don't transmit at the same time and significantly reduces the number of collisions and corresponding transmissions, especially when the number of active users increases. Accordingly, process 400 proceeds to check whether the medium is free (inquiry task 428) by checking the NAV time as explained above. If process 400 determines that the medium is free, then the wireless terminal sends the ad-hoe and/or the infrastructure data, stored in it's outbound queue, out to the transmission medium (task 430) and returns to task 402. Otherwise, process 400 leads back to inquiry task 428 to wait for transmission of the outbound ad-hoc and/or infrastructure data unless the medium is free.

With this approach a wireless terminal communicates concurrently with an infrastructure access point and an ad-hoc device.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A system for concurrent ad-hoc and infrastructure connectivity for a wireless LAN, the system comprising:
an infrastructure access point;
an ad-hoc device in communication with the infrastructure access point; and
a wireless terminal device configured to communicate concurrently with the infrastructure access point and the ad-hoc device.

2. The system according to claim 1, wherein the wireless LAN is in compliance with an Ethernet protocol.

3. The system according to claim 1, wherein the infrastructure access point is in compliance with an Ethernet protocol.

4. The system according to claim 1, wherein the ad-hoc device is in compliance with an Ethernet protocol.

5. The system according to claim 1, wherein the ad-hoc device is a wireless audio headset.

6. The system according to claim 1, wherein the ad-hoc device is a bar-code scanner.

7. The system according to claim 1, wherein the wireless terminal device comprises:
a radio module configured to wirelessly receive signals that convey a plurality of parameters corresponding to communication operation modes from the wireless LAN; and
a processor architecture coupled to the radio module and configured to:
select an infrastructure communication operation mode;
select an ad-hoc device communication operation mode;
select a system communication operation mode; and
communicate concurrently with the infrastructure access point and the ad-hoc device, if the system communication operation mode indicates a concurrent operation mode.

8. The system according to claim 7, further comprising a user interface coupled to the processor architecture and configured to allow user selection of:
the infrastructure communication operation mode;
the ad-hoc device communication operation mode; and
the system communication operation mode.

9. The system according to claim 7, wherein the system communication operation mode comprises concurrent communication with the infrastructure access point and the ad-hoc device.

10. A method for operating a concurrent ad-hoc and infrastructure connectivity system having a wireless terminal device in a wireless LAN, the method comprising:
selecting an infrastructure communication operation mode;
selecting an ad-hoc device communication operation mode;
selecting a system communication operation mode; and
communicating concurrently with an infrastructure access point and an ad-hoc device, if the system communication operation mode indicates a concurrent operation mode.

11. The method according to claim 10, further comprising configuring the wireless terminal device according to the infrastructure communication operation mode and the system communication operation mode.

12. The method according to claim 10, wherein the infrastructure communication operation mode is associated with the operation of a wireless LAN configuration in compliance with an Ethernet protocol.

13. The method according to claim 10, wherein the ad-hoc device communication operation mode is associated with the operation of a wireless LAN configuration in compliance with an Ethernet protocol.

14. The method according to claim 10, wherein the system communication operation mode is associated with concurrent communication with the infrastructure access point and the ad-hoc device.

15. A wireless terminal device configured to communicate concurrently with an infrastructure access point and an ad-hoc personal device in a wireless network, the wireless terminal device comprising:
a radio module configured to wirelessly receive signals that convey a plurality of parameters corresponding to a plurality of communication operation modes on the wireless network; and
a processor architecture coupled to the radio module and configured to:
select an infrastructure communication operation mode;
select an ad-hoc device communication operation mode;
select a common communication operation mode; and
communicate concurrently with the infrastructure access point and the ad-hoc personal device, if the common communication operation mode indicates a concurrent operation mode.

16. The wireless terminal device according to claim 15, further comprising a user interface coupled to the processor architecture and configured to allow user selection of:
the infrastructure communication operation mode;
the ad-hoc device communication operation mode; and
the common communication operation mode.

17. A method for operating a concurrent communication system having a wireless terminal device in a wireless LAN, the method comprising:
selecting a first communication operation mode for a first device;
selecting a second communication operation mode for a second device;
selecting a common communication operation mode; and
communicating concurrently with the first and the second device, if the common communication operation mode indicates a concurrent operation mode.

18. A method according to claim 17, wherein the communicating step further comprises:
receiving a packet intended for the wireless terminal device;
identifying a device that has sent the packet;
determining a packet type of the packet;
if the device is the first device and the packet type is outbound, storing the packet to obtain a first device outbound data;
if the device is the second device and the packet type is outbound, storing the packet to obtain a second device outbound data;
adding the first device outbound data to the second device outbound data to obtain a concurrent data; and
transmitting the concurrent data.

19. The method according to claim 17, further comprising configuring the wireless terminal device according to:
the first communication operation mode;
the second communication operation mode; and
the common communication operation mode.

20. The method according to claim 19, wherein the common communication operation mode comprises concurrent communication with the first and the second device.

21. The method according to claim 17, wherein selecting the first communication operation mode comprises selecting a wireless LAN configuration in compliance with an Ethernet protocol.

22. The method according to claim 17, wherein the selecting the second communication operation mode comprises selecting a wireless LAN configuration in compliance with an Ethernet protocol.

23. A method for concurrent ad-hoc and infrastructure data communication for a system having a wireless terminal device in a wireless LAN, the method comprising:
receiving a packet intended for the wireless terminal device;
identifying a device that has sent the packet;
determining a packet type of the packet;
if the device is an ad-hoc device and the packet type is outbound, storing the packet to obtain an ad-hoc outbound data;
if the device is an infrastructure device and the packet type is outbound, storing the packet to obtain an infrastructure outbound data;
adding the ad-hoc outbound data to the infrastructure outbound data to obtain a combined ad-hoc and infrastructure data; and
transmitting the combined ad-hoc and infrastructure data concurrently.

24. A method according to claim 23, future comprising:
generating a first message indicating arrival of an ad-hoc inbound packet, if the device is the ad-hoc device and the packet is the ad-hoc inbound packet; and
generating a second message indicating arrival of an infrastructure inbound packet, if the device is the infrastructure device and the packet is the infrastructure inbound packet.

25. The method according to claim 23, wherein the receiving step receives the packet in the wireless LAN in compliance with an Ethernet protocol.

26. The method according to claim 23, wherein the determining step determines the device in the wireless LAN in compliance with an Ethernet protocol.

27. The method according to claim 23, further comprising waiting for transmitting the combined ad-hoc and infrastructure data until a transmission medium is free.

28. The method according to claim 27, further comprising calculating a network allocation vector (NAV) time to check whether the transmission medium is free.

29. The method according to claim 23, wherein the combined ad-hoc and infrastructure data is stored in a main outbound queue of the wireless terminal device.
